(19) United States
(12) Patent Application Publication
(10) Pub. No.: US 2009/0118424 A1
(43) Pub. Date: May 7, 2009

(54) POLYVINYL ACETALS CONTAINING UNSATURATED ACETAL UNITS

(75) Inventor: Kurt Stark, Neuhaus (DE)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 11/718,648

(22) PCT Filed: Oct. 20, 2005
(86) PCT No.: PCT/EP2005/011298

§ 371 Date: May 4, 2007

(30) Foreign Application Priority Data
Nov. 4, 2004 (DE) 10 2004 053 312.1

(51) Int. Cl. C08F 116/06

(52) U.S. Cl. 525/56

(57) ABSTRACT

Polyvinyl acetals with unsaturated acetal units are obtained by means of acetalization of partly hydrolysed or fully hydrolysed vinyl ester polymers having >50 mol % of vinyl alcohol units with one or more saturated, aliphatic aldehydes and one or more unsaturated, acyclic aliphatic aldehydes, the aldehydes optionally used in the form of their hemiacetals or full acetals.

The invention relates to polyvinyl acetals with unsaturated acetal units, to processes for their preparation and to their use.

The preparation of polyvinyl acetals which are obtained from the corresponding polyvinyl alcohols by polymer-like reaction with the appropriate aldehydes has been known since as early as 1924, and a multitude of aldehydes have been used in the subsequent time to prepare the corresponding polyvinyl acetals. Polyvinyl acetals are prepared in a 3-stage process (polyvinyl acetate→polyvinyl alcohol→polyvinyl acetal), to result in products which, in addition to vinyl acetal groups, also contain vinyl alcohol and vinyl acetate units. Commercial significance has been gained in particular by polyvinyl formal, polyvinyl acetacetal and polyvinyl butyral (PVB). Hereinbelow, polyvinyl acetals with unsaturated acetal units will be understood to mean those which, in addition to the three vinyl acetate, vinyl alcohol and vinyl acetal units mentioned, also contain further vinyl acetal groups which have one or more unsaturated groups.

The largest application sector for polyvinyl acetals is the production of safety glass in automobile construction and in architecture, in which plasticized polyvinyl butyral films are used as an intermediate layer in glass panes. For this end use, mixtures with modified polyvinyl butyrals are also proposed, for example with the sulphonate-, carboxylate- and phosphate-functional acetal units described in EP-A 368832, which feature improved blocking and flow performance.

A further field of use for polyvinyl butyrals is the use in corrosion-protecting coatings, which can be taken, for example, from EP-A 1055686, in which polyvinyl acetals modified with tertiary alkanolamines are used.

Owing to their good pigment binding power among other reasons, polyvinyl butyrals are also used as binders in coating compositions and especially in printing inks. This application demands that the organic solutions of the polyvinyl butyrals should have minimum solution viscosity in order to be able to use them to produce inks with a high solids content at minimum binder fraction. Examples thereof are the modified polyvinyl butyrals with low solution viscosity from DE-A 19641064, which are obtained by acetalization of a copolymer having vinyl alcohol and 1-alkylvinyl alcohol units.

It is therefore an object of the invention to provide polyvinyl acetals in a simple, economic and effective manner, which can be modified in a very wide variety of ways.

The object is achieved with polyvinyl acetals which bear reactive unsaturated groups on the side chains, on which further reactions may be undertaken.

However, the introduction of unsaturated groups into polyvinyl acetals is found to be very difficult. The abovementioned 3-stage process cannot be carried out starting from the polyvinyl acetate resin, since, when specific unsaturated monomers are used, these double bonds are consumed in the course of the free-radical polymerization of vinyl esters. This means that, after hydrolysis and acetalization, no free double bonds are present any longer. U.S. Pat. No. 5,055,518 describes the reaction of partly acetalized polyvinyl alcohols with unsaturated isocyanates to obtain polyvinyl acetals with ethylenically unsaturated carbamate groups. A problem in this context is that the isocyanates are extremely water-sensitive and the isocyanate is decomposed to the inert amine in the event of minimal traces of water. JP-A 62-141003 describes the acetalization of polyvinyl alcohol with unsaturated cyclic carboaldehydes. A disadvantage in this context is the high cost and the low reactivity of the unsaturated carbocycles in grafting.

The invention provides polyvinyl acetals with unsaturated acetal units, obtainable by means of acetalization of partly hydrolysed or fully hydrolysed vinyl ester polymers having >50 mol % of vinyl alcohol units with one or more saturated, aliphatic aldehydes and one or more unsaturated, acyclic, aliphatic aldehydes, it also being possible to use the aldehydes in the form of their hemiacetals and full acetals. Suitable partly hydrolysed or fully hydrolysed vinyl ester polymers derive from polymers which contain 50 to 100 mol % of vinyl ester units. Suitable vinyl esters are vinyl esters of unbranched or branched carboxylic acids having 1 to 15 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 5 to 11 carbon atoms, for example VeoVa9R or VeoVa10R (trade name of Resolutions). Particular preference is given to vinyl acetate.

In addition to the vinyl ester units, one or more monomers from the group comprising methacrylic esters and acrylic esters of alcohols having 1 to 15 carbon atoms, olefins, dienes, vinyl aromatics and vinyl halides may optionally be copolymerized. Suitable monomers from the group of the esters of acrylic acid or methacrylic acid are esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-, iso- and t-butyl acrylate, n-, iso- and t-butyl methacrylate, 2-ethylhexyl acrylate, norbornyl acrylate. Particular preference is given to methyl acrylate, methyl methacrylate, n-, iso- and t-butyl acrylate, 2-ethylhexyl acrylate and norbornyl acrylate. Suitable dienes are 1,3-butadiene and isoprene. Examples of polymerizable olefins are ethene and propene. Vinyl aromatics which may be copolymerized are styrene and vinyltoluene. From the group of the vinyl halides, typically vinyl chloride, vinylidene chloride or vinyl fluoride, preferably vinyl chloride, are used. The fraction of these comonomers is such that the fraction of vinyl ester monomer is >50 mol % in the vinyl ester polymer.

Optionally, further comonomers may also be present in a fraction of preferably 0.01 to 20% by weight based on the total weight of the vinyl ester polymer. Examples thereof are ethylenically unsaturated mono- and dicarboxylic acids, preferably crotonic acid, acrylic acid, methacrylic acid, itaconic acid, fumaric acid and maleic acid; ethylenically unsaturated carboxamides and carbonitriles, preferably N-vinylformamide, acrylamide and acrylonitrile; also cyclic amides which bear an unsaturated group on the nitrogen, such as N-vinylpyrrolidone; mono- and diesters of fumaric acid and maleic acid, such as the diethyl and diisopropyl esters, and also maleic anhydride, ethylenically unsaturated sulphonic acids and their salts, preferably vinylsulphonic acid, 2-acrylamido-2-methylpropanesulphonic acid. Suitable auxiliary monomers are also cationic monomers such as diallyldimethyl-ammonium chloride (DADMAC), 3-trimethylammoniopropyl(meth)-acrylamide chloride (MAPTAC) and 2-trimethylammonioethyl (meth)acrylate chloride. Also suitable as auxiliary monomers are vinyl ethers, vinyl ketones, further vinylaromatic compounds which may also have heteroatoms.

Suitable auxiliary monomers are also polymerizable silanes or mercapto silanes. Preference is given to γ-acryloyl- or γ-methacryloyloxypropyltri(alkoxy)silanes, α-methacryloyloxymethyltri(alkoxy)silanes, γ-methacryloyloxypropylmethyldi(alkoxy)silanes, vinylalkyldi(alkoxy)silanes and vinyltri(alkoxy)silanes, in which the alkoxy groups used may, for example, be methoxy, ethoxy, methoxyethylene, ethoxyethylene, methoxypropylene glycol ether or ethoxypropylene glycol ether radicals. Examples thereof are vinyltrimethoxysilane, vinyl-triethoxysilane, vinyltripropoxysilane, vinyltriisopropoxy-silane, vinyltris(1-methoxy)isopropoxysilane, vinyltri-butoxysilane, vinyltriacetoxysilane, 3-methacryloyloxypropyl-trimethoxysilane, 3-methacryloyloxypropylmethyldimethoxy-silane, methacryloyloxymethyltrimethoxysilane, 3-methacryloyl-oxypropyltris(2-methoxyethoxy)silane, vinyltrichlorosilane, vinylmethyldichlorosilane, vinyltris(2-methoxyethoxy)silane, trisacetoxyvinylsilane, 3-(triethoxysilyl)propylsuccinic anhydride silane. Preference is also given to 3-mercapto-propyltriethoxysilane, 3-mercaptopropyltrimethoxysilane and 3-mercaptopropylmethyldimethoxysilane.

Further examples are functionalized (meth)acrylates or vinyl ethers, in particular epoxy-functional (meth)acrylates or vinyl ethers, such as glycidyl acrylate, glycidyl methacrylate, allyl glycidyl ether, vinyl glycidyl ether, or hydroxyalkyl-functional (meth)acrylates such as hydroxyethyl (meth)acrylate, or substituted or unsubstituted aminoalkyl (meth)acrylates.

Further examples are precrosslinked comonomers such as ethylenically polyunsaturated comonomers, for example divinyl adipate, diallyl maleate, allyl methacrylate, butanediol diacrylate or triallyl cyanurate, or postcrosslinked comonomers, for example acrylamidoglycolic acid (AGA), methyl methylacrylamidoglycolate (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate.

These vinyl ester polymers are commercially available or may be prepared in a known manner by means of polymerization; preferably by bulk polymerization, suspension polymerization or by polymerization in organic solvents, more preferably in alcoholic solution. Suitable solvents and regulators are, for example, methanol, ethanol, propanol, isopropanol. The polymerization is carried out under reflux at a temperature of from 40° C. to 100° C. and free-radically initiated by addition of common initiators. Examples of common initiators are azo initiators, or percarbonates such as cyclohexyl peroxydicarbonate, or peresters such as t-butyl perneodecanoate or t-butyl perpivalate. The molecular weight can be adjusted in a known manner by addition of regulators, by the solvent content, by variation of the initiator concentration and by variation of the temperature. On completion of the polymerization, the solvent and any excess monomer and regulator are distilled off.

The vinyl ester polymers are hydrolysed in a manner known per se, for example by the belt or kneader process, under alkaline or acidic conditions, with addition of acid or base. Preference is given to taking up the solid vinyl ester resin in alcohol, preferably methanol, with establishment of a solids content of 10 to 80% by weight. Preference is given to carrying out the hydrolysis under basic conditions, for example by addition of NaOH, KOH or NaOCH3. The base is used generally in an amount of 1 to 5 mol % per mole of ester units. The hydrolysis is carried out at temperatures of 25° C. to 80° C. On completion of the hydrolysis, the solvent is distilled off and the polyvinyl alcohol is obtained as a powder. However, the polyvinyl alcohol may also be obtained as an aqueous solution by gradual addition of water while the solvent is distilled off.

Fully hydrolysed vinyl ester polymers refer to polymers whose degree of hydrolysis is ≧96 mol %. Partly hydrolysed polyvinyl esters refer to those having a degree of hydrolysis of >50 mol % and <96 mol %. The partly or fully hydrolysed vinyl ester polymers preferably have a degree of hydrolysis of 50 mol % to 99.9 mol %, more preferably of 70 mol % to 99.9 mol %, most preferably of 96 mol % to 99.9 mol %. The viscosity of the polyvinyl alcohol (DIN 53015, Höppler method; 4% solution in water) is 1 to 60 mPas, preferably 1 to 10 mPas, and serves as a measure of the molecular weight and of the degree of polymerization of the partly or fully hydrolysed vinyl ester polymers. The degree of polymerization of the polyvinyl alcohol used is at least 100.

Preferred unsaturated, acyclic, aliphatic aldehydes, in which the aldehyde function may also be present as a hydrate, hemiacetal or full acetal, can be specified by the following structural formula: R²-[CR⁴═CR^{4]}_{z}-{CHR¹}_{y}-(CH₂)ₓ- CH═O. In the structural formula, R¹ is a branched, saturated or unsaturated, optionally substituted alkyl radical which has 1 to 20 carbon atoms and may optionally be interrupted by heteroatoms of the N, O, S type. R¹ is also defined as O-R³ where R³ is a vinyl, (meth)acryloyl, allyl or styryl radical. R² is H or an alkyl, alkenyl, (meth)acryloyl or styryl radical. R⁴ may be the same or different and is H or a branched, saturated or unsaturated, optionally substituted alkyl radical which has 1 to 20 carbon atoms and may optionally be interrupted by heteroatoms of the N, O, S type. x and y describe the number of the abovementioned repeat units of the corresponding moiety, the sum total of these particular moieties being integers between 0 and 40. z is an integer of 0 to 10, where, when z=0, at least one of the Rⁱ radicals is unsaturated. The arrangement of the (CH₂)_{X}, (CHR₂)_{y}, (CR⁴═CR⁴)_{z} structural elements may be blocklike, alternating or distributed randomly along the chain.

Particularly preferred aldehydes of the above structural formula are acrolein (2-propenal), crotonaldehyde (2-butenal), 2-ethylhexenal, pentenal, hexenal, heptenal and 3-(meth)acryloylbutyraldehyde. Most preferred are acrolein and crotonaldehyde.

The unsaturated, acyclic, aliphatic aldehydes are used in mixtures with one or more saturated, aliphatic aldehydes in order to obtain an unsaturated polyvinyl acetal. Suitable saturated aldehydes are those from the group comprising aliphatic aldehydes having 1 to 15 carbon atoms, and also their hydrates, hemiacetals and full acetals. Preference is given to formaldehyde, acetaldehyde, propionaldehyde. Particular preference is given to butyraldehyde or mixtures of butyraldehyde and acetaldehyde.

The fraction of acetal units which bear unsaturated groups ranges from 0.01 to 60% by weight, more preferably from 0.1 to 40% by weight and most preferably from 0.5 to 20% by weight, based on the total weight of the saturated vinyl acetal units and unsaturated vinyl acetal units.

The degree of acetalization of the polyvinyl acetals with unsaturated acetal units is 1 to 80 mol %, in the preferred ranges 1 to 25 mol % and 40 to 80 mol %. The viscosity of the unsaturated polyvinyl acetals (DIN 53015; Höppler method, 10% solution in ethanol) is 4 mPas to 1200 mPas, preferably 4 to 120 mPas.

The polyvinyl acetals with unsaturated acetal units may be present as a solid in solution or in suspension, preferably aqueous suspension. Aqueous suspensions of the unsaturated polyvinyl acetals may be stabilized with anionic, zwitterionic, cationic and nonionic emulsifiers, and also protective colloids. Preference is given to using zwitterionic or anionic emulsifiers, optionally also in mixtures. The nonionic emulsifiers used are preferably condensation products of ethylene oxide or propylene oxide with linear or branched alcohols having 8 to 18 carbon atoms, alkylphenols or linear or branched carboxylic acids of 8 to 18 carbon atoms, and also block copolymers of ethylene oxide and propylene oxide. Suitable anionic emulsifiers are, for example, alkyl sulphates, alkylsulphonates, alkyl aryl sulphates, and also sulphates or phosphates of condensation products of ethylene oxide with linear or branched alkyl alcohols and with 2 to 25 EO units, alkylphenols, and mono- or diesters of sulphosuccinic acid.

Suitable zwitterionic emulsifiers are, for example, alkyldimethylamine oxides in which the alkyl chain has 6-16 carbon atoms. The cationic emulsifiers used may, for example, be tetraalkylammonium halides such as C₆-C₁₆-alkyltrimethyl-ammonium bromide. It is likewise possible to use trialkylamines having one longer (≧5 carbon atoms) and two shorter hydrocarbyl radicals (<5 carbon atoms), which are present in protonated form in the course of the acetalization, which proceeds under strongly acidic conditions, and can function as an emulsifier. The amount of emulsifier is 0.01 to 20% by weight based on the total weight of the unsaturated polyvinyl acetal in the mother liquor. Preference is given to an amount of 0.01 to 2% by weight of emulsifier, particular preference to an amount of 0.01 to 1% by weight of emulsifier based on the unsaturated polyvinyl acetal.

For the acetalization, the partly or fully hydrolysed polyvinyl esters are preferably taken up in aqueous medium. Typically, a solids content of the aqueous solution of 4 to 30% is established. The acetalization is effected in the presence of acidic catalysts such as hydrochloric acid, sulphuric acid, nitric acid or phosphoric acid. Preference is given to adjusting the pH of the solution to values of <1 by adding 20% hydrochloric acid.

After addition of the catalyst, the solution is cooled to preferably −10° C. to +30° C. The lower the molecular weight of the modified polyvinyl alcohol used, the lower will be the precipitation temperature selected. The acetalization reaction is started by adding the aldehyde(s), it being possible to use, as well as a saturated aldehyde, at least one unsaturated aldehyde or its hemiacetal or full acetal. The amount added depends upon the desired degree of acetalization. Since the acetalization proceeds with almost full conversion, the amount added can be determined by simple stoichiometric calculation. Since a mixture of saturated and unsaturated aldehydes is used, the ratio is calculated from the content of unsaturated acetal groups to be achieved in the polyvinyl acetal, the desired degree of acetalization and from the molecular weight of the unsaturated aldehydes used. After completion of the addition of the aldehyde, the acetalization is completed by heating the mixture to from 10° C. to 60° C. and stirring for several hours, preferably for 1 to 6 hours, and the pulverulent reaction product is isolated by filtration and a subsequent washing step. For stabilization, alkalis may also be added. During the precipitation and the aftertreatment, it is possible to work with emulsifiers in order to stabilize the aqueous suspension of the polyvinyl acetal with unsaturated acetal units.

In a particularly preferred process, one or more aldehydes having unsaturated groups or their hemiacetals or full acetals are initially added to the aqueous solution of the polyvinyl alcohol, preferably above the precipitation temperature. Catalyst, for example hydrochloric acid, is used to adjust to a pH of 0 to 5, so that the unsaturated aldehydes can pre-react with the polyvinyl alcohol. Subsequently, the precipitation of the polyvinyl acetal is undertaken at the precipitation temperature by adding one or more saturated aldehydes. For the precipitation, further catalysts may optionally be added. This is followed by the above-described workup process.

The inventive procedure provides polyvinyl acetals with unsaturated acetal units. In this polymer, unsaturated groups are available, on which further reactions, for example free-radical grafting reactions, addition reactions or crosslinking reactions, may be undertaken. This allows the properties and the performance, starting from unsaturated polyvinyl acetals, in contrast to the conventional polyvinyl acetals, to be improved to a great extent and for many applications. The polyvinyl acetals with unsaturated acetal units therefore find use as reactants for the chemical modification of polyvinyl acetals.

The polyvinyl acetals with unsaturated acetal units additionally find use in the fields of use typical for polyvinyl acetals: these are use as a film in safety glass and as acoustic film, as binders in printing inks, as binders in primers, as binders in corrosion protectants, as binders in the ceramics industry, specifically as binders for green ceramic bodies. Mention should also be made of use as binders for ceramic powders and metal powders in powder injection moulding, as binders for glass fibres and as binders for the internal coating of cans, optionally in combination with crosslinkers such as epoxy resins.

The examples which follow serve to further illustrate the invention without restricting it in any way:

### Example 1

A 6 l glass reactor was initially charged with 2690 ml of dist. water, 1114 ml of 20% hydrochloric acid (HCl) and 1160 ml of a 20% aqueous solution of a fully hydrolysed polyvinyl alcohol (viscosity 3.0 mPas; DIN 53015; Höppler method; 4% aqueous solution). The mixture was then cooled with stirring to 10° C. and 4.9 g of acrolein were added at this temperature. Acrolein was pre-reacted with the polyvinyl alcohol at 10° C. for 30 min, as a result of which effective initial attachment took place. Subsequently, the mixture was cooled to −1° C. and 148.6 g of butyraldehyde were added within a period of 5 minutes. In the course of this, the internal reactor temperature rose to 0.5° C. Within a very short time, the mixture was cooled again to −1° C. 3 minutes after addition of the butyraldehyde, the initially clear mixture became milky and opaque, and only 5 minutes later, the product precipitated out in a pulverulent form. After 40 minutes of reaction time at −1° C., the temperature was increased to 25° C. over a period of 105 minutes and this temperature was maintained for a further 90 minutes. The pulverulent product was then filtered off and washed with distilled water until the filtrate had a neutral reaction. Subsequently, drying was effected down to a solids content of at least 98%, first at 22° C. then at 35° C. under reduced pressure. An unsaturated polyvinyl butyral with 18.18% by weight of vinyl alcohol units was obtained (according to 1H NMR spectroscopy). The vinyl acetate content was 1.58% by weight. The butyral content was 77.58% by weight and the acrolein acetal content was 2.66% by weight. The glass transition temperature Tg was determined to be 67.6° C. The viscosity (DIN 53015; Höppler method; 10% ethanolic solution) was 20.2 mpas.

### Example 2

As Example 1, with the difference that 2.5 g of acrolein and 151.2 g of butyraldehyde were used for the acetalization. An unsaturated polyvinyl butyral with 19.06% by weight of vinyl alcohol units was obtained (according to 1H NMR spectroscopy). The vinyl acetate content was 1.28% by weight. The butyral content was 78.50% by weight and the acrolein acetal content was 1.16% by weight. The glass transition temperature Tg was determined to be 67.5° C. The viscosity (DIN 53015; Höppler method; 10% ethanolic solution) was 19.5 mPas.

It was found that the double bonds in the unsaturated polyvinyl butyral have been preserved fully even after a prolonged storage time of 6 months, which was proved with 1H NMR spectroscopy.

### Example 3

The procedure was analogous to Example 1 with the difference that the acetalization was carried out with 10.2 g of acrolein and 143.6 g of butyraldehyde. An unsaturated polyvinyl butyral with 17.95% by weight of vinyl alcohol units was obtained (according to 1H NMR spectroscopy). The vinyl acetate content was 1.72% by weight. The butyral content was 74.31% by weight and the acrolein acetal content was 6.02% by weight. The glass transition temperature Tg was determined to be 67.2° C. The viscosity (DIN 53015; Höppler method; 10% ethanolic solution) was 20.2 mPas.

### Example 4

The procedure was analogous to Example 1 with the difference that the acetalization was carried out with 20.4 g of acrolein and 133.6 g of butyraldehyde.

An unsaturated polyvinyl butyral with 18.11% by weight of vinyl alcohol units was obtained (according to 1H NMR spectroscopy). The vinyl acetate content was 1.69% by weight. The butyral content was 71.03% by weight and the acrolein acetal content was 9.17% by weight. The glass transition temperature Tg was determined to be 70.2° C. The viscosity (DIN 53015; Höppler method; 10% ethanolic solution) was 19.9 mPas.

### Example 5

The procedure was analogous to Example 1 with the difference that the acetalization was carried out with 29.8 g of acrolein and 124.8 g of butyraldehyde. An unsaturated polyvinyl butyral with 18.45% by weight of vinyl alcohol units was obtained (according to 1H NMR spectroscopy). The vinyl acetate content was 1.71% by weight. The butyral content was 67.65% by weight and the acrolein acetal content was 12.19% by weight. The glass transition temperature Tg was determined to be 71.1° C. The viscosity (DIN 53015; Höppler method; 10% ethanolic solution) was 20.4 mPas.

### Example 6

The procedure was analogous to Example 1 with the difference that the acetalization was carried out with 40.0 g of acrolein and 115.1 g of butyraldehyde. An unsaturated polyvinyl butyral with 18.66% by weight of vinyl alcohol units was obtained (according to 1H NMR spectroscopy). The vinyl acetate content was 1.72% by weight. The butyral content was 63.35% by weight and the acrolein acetal content was 16.27% by weight. The glass transition temperature Tg was determined to be 72.6° C. The viscosity (DIN 53015; Höppler method; 10% ethanolic solution) was 21.4 mpas.

### Example 7

The procedure was analogous to Example 4 with the difference that, instead of acrolein, the unsaturated aldehyde used was 20.4 g of crotonaldehyde. In addition, 143.6 g of butyraldehyde were used. An unsaturated polyvinyl butyral with 19.38% by weight of vinyl alcohol units was obtained (according to 1H NMR spectroscopy). The vinyl acetate content was 1.80% by weight. The butyral content was 77.41% by weight and the crotonaldehyde acetal content was 1.41% by weight. The glass transition temperature Tg was determined to be 67.5° C. The viscosity (DIN 53015; Höbppler method; 10% ethanolic solution) was 19.8 mPas.

### Example 8

The procedure was analogous to Example 6 with the difference that, instead of acrolein, the unsaturated aldehyde used was 40.0 g of crotonaldehyde. In addition, 143.6 g of butyraldehyde were used. An unsaturated polyvinyl butyral with 20.04% by weight of vinyl alcohol units was obtained (according to 1H NMR spectroscopy). The vinyl acetate content was 1.64% by weight. The butyral content was 75.98% by weight and the crotonaldehyde acetal content was 2.34% by weight. The glass transition temperature Tg was determined to be 67.5° C. The viscosity (DIN 53015; Höppler method; 10% ethanolic solution) was 20.3 mPas.

### Example 9

The procedure was analogous to Example 8 with the difference that, instead of crotonaldehyde, the unsaturated aldehyde used was 40.0 g of 2-ethylhexenal. An unsaturated polyvinyl butyral with 21.55% by weight of vinyl alcohol units was obtained (according to 1H NMR spectroscopy). The vinyl acetate content was 1.45% by weight. The butyral content was 75.67% by weight and the 2-ethylhexenal acetal content was 1.33% by weight. The glass transition temperature Tg was determined to be 64.2° C. The viscosity (DIN 53015; Höppler method; 10% ethanolic solution) was 19.7 mPas.

### Example 10

A 6-litre glass reactor was initially charged with 2617 ml of dist. water, 826 ml of 20% HCl and 1355 ml of 20.0% aqueous solution of a fully hydrolysed polyvinyl alcohol having a viscosity of 2.4 mPas (DIN 53015; Höppler method; 4% aqueous solution). The initial charge was cooled to 10° C. with stirring and subsequently admixed with 10.0 g of acrolein. The acrolein was pre-reacted with the polyvinyl alcohol at 10° C. for 30 min, as a result of which effective initial attachment took place. After further cooling to the precipitation temperature of 5° C., 62.6 g of acetaldehyde were added within 5 min. 20 minutes, later at an internal reactor temperature of 5° C., 80.2 g of butyraldehyde were added. From this time, the temperature of 5° C. was retained for another 40 minutes and subsequently increased to 25° C. over a period of 3.5 hours. This temperature was retained for a further 2 hours. The product was then filtered and washed with distilled water until the filtrate had a neutral reaction. Subsequently, drying was effected up to a solids content of at least 98%, first at 22° C., then at 35° C. under reduced pressure. An unsaturated polyvinyl acetal with 13.38% by weight of vinyl alcohol units was obtained (according to 1H NMR spectroscopy). The vinyl acetate content was 1.45% by weight. The butyral content was 39.27% by weight, the acetate acetal content was 40.31% by weight and the acrolein acetal content was 5.59% by weight. The glass transition temperature Tg was determined to be 72.7° C. The viscosity (DIN 53015; Höppler method; 10% ethanolic solution) was 16.3 mPas.

As is evident from the examples, the reaction of polyvinyl alcohol with acrolein proceeds almost quantitatively. This does not impair the further acetalization with saturated aldehydes, such as butyraldehyde or acetaldehyde, which likewise proceeds quantitatively. This shows that the preparation of unsaturated polyvinyl acetals with the process according to the invention can be carried out in a very simple manner. Crotonaldehyde is distinctly less reactive with regard to the acetalization of polyvinyl alcohol, while it is necessary to work with a very large excess in the case of 2-ethylhexenal in order to acetalize at least a small portion of polyvinyl alcohol. Apparently, the acetalization proceeds with ever greater difficulty the longer and the more branched the unsaturated aldehyde used is. This can be explained firstly by a reduced water solubility, and steric influences might secondly also play a role.

1.-14. (canceled)

15. Polyvinyl acetals with unsaturated acetal units are obtained by acetalizing partly hydrolysed or fully hydrolysed vinyl ester polymers having >50 mol % of vinyl alcohol units with one or more saturated, aliphatic aldehydes and one or more unsaturated, acyclic aliphatic aldehydes, the aldehydes optionally employed in the form of their hemiacetals and/or full acetals, wherein the portion of unsaturated acetal groups is from 0.5 to 20 weight percent based on the total of unsaturated acetal groups and saturated acetal groups.

16. A polyvinyl acetal of claim 15, obtained from aldehydes of the formula R²-[CR⁴═CR⁴]_{z}-{CHR¹}_{y}-(CH₂)ₓ-CH═O, where R¹ is a branched, saturated or unsaturated, optionally substituted C₁₋₂₀ alkyl radical optionally interrupted by heteroatoms of N, O, or S, or R¹ is defined as O-R³ where R³ is a vinyl, (meth)acryloyl, allyl or styryl radical, and R² is H or an alkyl, alkenyl, (meth)acryloyl or styryl radical, and R⁴ may be the same or different and is H or a branched, saturated or unsaturated, optionally substituted C₁₋₂₀ alkyl radical optionally interrupted by heteroatoms of N, O, or S, and x and y are each 0 to 40, the sum of x+y <40, and z=0 to 10.

17. A polyvinyl acetal of claim 15, wherein the unsaturated aldehydes are selected from the group consisting of acrolein, crotonaldehyde, 2-ethylhexenal, pentenal, hexenal, heptenal, 3-(meth)acryloylbutyraldehyde, and mixtures thereof.

18. A polyvinyl acetal of claim 15, wherein the saturated aldehydes are selected from the group consisting of aliphatic aldehydes having 1 to 15 carbon atoms, and mixtures thereof.

19. A polyvinyl acetal of claim 15, having a degree of acetalization of 1 to 80 mol %.

20. A process for preparing a polyvinyl acetal with unsaturated acetal units of claim 15, comprising acetalizing a partly hydrolysed or fully hydrolysed vinyl ester polymer having ≧50 mol % of vinyl alcohol units with one or more saturated, aliphatic aldehydes and one or more unsaturated, acyclic aliphatic aldehydes, the aldehydes being optionally in the form of their hemiacetals or full acetals.

21. The process of claim 20, further comprising prereacting unsaturated aldehyde with the partly hydrolysed or fully hydrolysed vinyl ester polymer and then the polyvinyl acetal by acetalizing with one or more saturated aldehydes.

22. The process of claim 20, further comprising subsequently chemically modifying the polyvinyl acetal.

23. In a binder in printing inks, primers and corrosion preventatives, the improvement comprising including as a binder component at least one polyvinyl acetal with unsaturated acetal units of claim 15.

24. In a ceramic or metal powder composition where a binder is employed, the improvement comprising incorporating, as at least one binder component, a polyvinyl acetal with unsaturated acetal units of claim 15.

25. The composition of claim 23 which is a powder composition for injection moulding.

26. In an internal can coating containing a binder, the improvement comprising incorporating into the coating at least one polyvinyl acetal with unsaturated acetal units of claim 15 as a binder.

27. In a glass fiber composition wherein a binder is employed, the improvement comprising incorporating at least one polyvinyl acetal with unsaturated acetal units of claim 15 into said binder.
